(19) United States
(12) Patent Application Publication
(10) Pub. No.: US 2011/0284553 A1
(43) Pub. Date: Nov. 24, 2011

(54) COOKWARE LID WITH BORDER

(75) Inventors: Klaus Roth, Unlingen (DE); Hans Fingerle, Riedlingen (DE); Jochen Schobloch, Bad Buchau (DE)

(73) Assignee: SILIT-WERKE GMBH & CO. KG

(21) Appl. No.: 13/139,309

(22) PCT Filed: Sep. 29, 2009
(86) PCT No.: PCT/EP09/06999

§ 371 Date: Aug. 5, 2011

(30) Foreign Application Priority Data
Dec. 18, 2008 (DE) 08022037.9

(51) Int. Cl. A47J 36/06; B32B 37/00

(52) U.S. Cl. 220/573.1; 156/60

(57) ABSTRACT

A cookware lid, having a basic lid body and a surrounding border which are connected to each other by a sealing compound. The basic lid body can thereby be mechanically stably and watertightly connected to the border. Moreover, a high degree of flexibility as concerns the selection of material and the design of the border is achieved.

### CROSS-REFERENCE TO RELATED APPLICATION

The present application claims the benefit of priority of International Patent Application No. PCT/EP2009/006999, filed Sep. 29, 2009, which application claims priority of German Application No. 08022037.9, filed Dec. 18, 2008. The entire text of the priority application is incorporated herein by reference in its entirety.

### FIELD OF THE DISCLOSURE

The disclosure relates to a cookware lid with a basic lid body and a surrounding border as well as a method for the manufacture thereof.

### BACKGROUND

Many designs of lids for cookware are known. Among others, lids that are edged by a surrounding border are known. The term border shall be understood herein as those “edges” which do not only have a mere sealing or protecting function, such as in a seal or an edge protection ring in the narrow sense of the word, but also those which moreover comprise a rest surface to rest on the corresponding container and/or for deposition or storage purposes. It is already known to manufacture such borders of plastics for aesthetic reasons and for the benefit of being as free as possible as regards the design, but also because of advantageous sealing and adjustment properties.

For example, a cooking pot lid of metal with an edge protection ring of an elastomer having a border projecting downwards is known from the G 8209965. The edge protection ring is connected to the lid by means of a clip attachment. Alternatively, the metal lid can be provided with the edge protection ring in a plastics injection or pressing machine. This lid, however, is disadvantageous in that the connection between the basic lid body and the edge protection ring or the border is not always watertight. In some cases, it is not possible to clean such a lid satisfactorily, and it can therefore include dirt accumulations. Moreover, the material selection and the design of the border or the edge protection ring are restricted, depending on the attachment variant.

### SUMMARY OF THE DISCLOSURE

It is therefore one aspect of the disclosure to provide a cookware lid that is improved as concerns its manufacture and function.

According to the disclosure, this one aspect can be obtained by a cookware lid in which the basic lid body is connected to the border by means of a sealing compound.

It is thereby possible to diversely adjust the shape and material of the border to creative and technical requirements. Simultaneously, the sealing compound permits a permanently stable and watertight connection.

Favorably, the contour of the sealing compound is essentially adapted to the contours of the basic lid body (2) and the border (3). Thereby, a particularly good sealing effect of the connection is achieved.

In a particularly advantageous embodiment, the basic lid body and the border are connected with a watertight sealing compound. This permits particularly simple and thorough cleaning of the lid.

Preferably, the border comprises a rest surface arranged to surround the sealing compound for placing it onto a piece of cookware, where the cured sealing compound is hard enough not to be essentially deformed when the lid is placed onto the cookware. This permits a stable and simultaneously flat, and thus optically attractive lid edge.

Favorably, the basic lid body is transparent, in particular it is made of glass. This permits visual control during the preparation of a dish.

Preferably, the sealing compound consists of a material harmless for food. In this case, the sealing compound can be partially exposed on the inner side of the lid.

Preferably, the surface of the sealing compound has the shape of a concave meniscus. This permits an optically particularly attractive transition between the basic lid body and the border and is advantageous in view of hygiene.

Preferably, the border consists of a material harmless for food, in particular of plastics, resin or any other curing material. This spares an additional coating for its use in the kitchen.

In a preferred embodiment, the border comprises a silicone material. In this case, noise is dampened when the lid is being placed onto a pot or a solid base. Due to the thermal properties of silicone, the lid can be gripped at the border when it is hot without causing any burns.

In a preferred embodiment, a sealing edge is embodied at the border or at the basic lid body, the edge acting as a flow barrier for the sealing compound while the sealing compound is being introduced between the border and the basic lid body. Thereby, a region between the border and the basic lid body can be controlledly filled with sealing compound, and uncontrolled penetration or leakage of the sealing compound can be prevented.

Preferably, an accommodation region for a circumferential edge section of the basic lid body is embodied in the border, the volume of the accommodation region being larger than the volume of the edge section, and a space between the basic lid body and the border provided in the accommodation region is filled with the sealing compound. Thereby, a particularly stable and tight connection can be prepared.

Favorably, a vent gap is provided between the sealing edge and the basic lid body, permitting air to be displaced to escape from the space.

The above-noted one aspect of the disclosure is also achieved by a method in which a basic lid body and a border are provided and in which the basic lid body and the border are connected with a sealing compound.

Thereby, the shape and material of the border can be particularly well adjusted to creative and technical requirements. At the same time, the sealing compound permits a permanently stable and watertight connection.

In a particularly advantageous embodiment of the method, the sealing compound is introduced between the basic lid body and the border, where a sealing edge embodied in the border in combination with the basic lid body, or a sealing edge embodied at the basic lid body in combination with the border, act as flow barrier for the sealing compound. Thereby, a region between the border and the basic lid body can be controlled while it is filled with sealing compound.

Preferably, the sealing compound is introduced between the basic lid body and the border in a state where it is capable of flow and/or creep, while it adjusts to the contours of the basic lid body and the border. Thereby, a particularly good sealing effect of the connection is achieved.

### BRIEF DESCRIPTION OF THE DRAWINGS

Preferred embodiments of the disclosure are represented in the drawing and will be illustrated below, where the description of the first embodiment also applies to the other embodiments if nothing to the contrary is stated. In the drawings:

FIG. 1 shows a schematic plan view of a lid according to the disclosure;

FIG. 2 shows a schematic partial view of a first embodiment of the lid according to the disclosure in a section along line A in FIG. 1;

FIG. 3 shows a schematic partial view of the lid according to the disclosure in a section along line B in FIG. 2;

FIG. 4 shows a schematic partial view of a second embodiment of the lid according to the disclosure in a section along line A in FIG. 1;

FIG. 5 shows a schematic partial view of a third embodiment of the lid according to the disclosure in a section along line A in FIG. 1.

### DETAILED DESCRIPTION OF THE PREFERRED EMBODIMENT

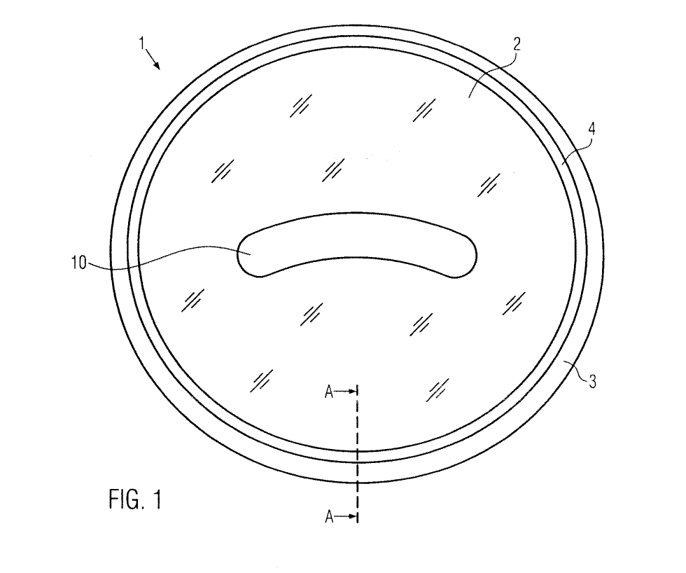

FIG. 1 shows a cookware lid 1 with a basic lid body 2 of glass, a border 3 surrounding its edge region 2a and a handle 10. The basic lid body 2 is connected to the border 3 by means of a sealing compound 4.

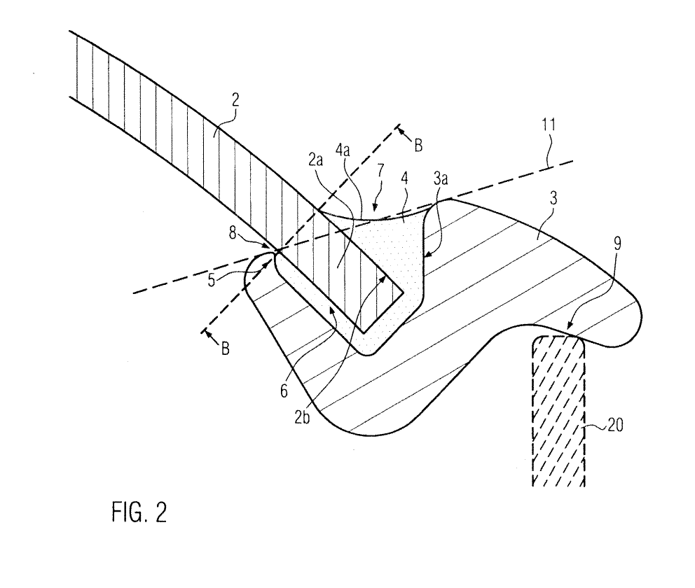

The border 3 can be fabricated as plastic piece, e.g. by injection molding, and in a first embodiment according to FIG. 2, it comprises an accommodation region 7 for the circumferential edge section 2a and the sealing compound 4. The accommodation region 7 is preferably manufactured with a clear oversize, so that the space 6 between the basic lid body 2 and the border 3 is formed and can be filled with the sealing compound 4. The cross-section of the accommodation region 7 according to FIG. 2 approximately corresponds to the region included by the contour of the border 3 and the connection line 11 between the upper edges of the accommodation region 7 or the border 3, respectively. Thus, the volume of the accommodation region 7 is larger than the volume of the circumferential edge section 2a.

The basic lid body 2 and the border 3 are permanently connected to each other so as to be watertight by means of the sealing compound 4. By way of example, the connection surfaces 2b and 3a of the basic lid body 2 or the border 3, respectively, are represented. The sealing compound 4 essentially completely fills the accommodation region 7, in particular, however, the space 6. At the end of the space 6 at the inner side of the lid which limits the accommodation region 7, a sealing edge 5 is formed in the border 3. This edge prevents the sealing compound 4 that is still capable of flow or creep, respectively, from escaping from the space 6 during manufacture.

As indicated in FIG. 2, a small vent gap 8 is provided between the basic lid body 2 and the sealing edge 5, the vent being selected to be just large enough to let air escape from the space 6 to be filled during the introduction of the sealing compound 4.

At the bottom side of the border 3, a rest surface 9 to rest on a pot 20 indicated in a broken line is formed. The rest surface 9 is inclined and thereby permits the lid 1 to automatically center on the pot 20 and seal the same when it is placed or pressed onto it. However, the lid can possibly also be placed on the pot such that it is not impermeable.

The lid 1 is a part of a piece of cookware, such as a cooking pot, a steamer, a roaster or a pan. The lid 1 does not have to be round as shown in FIG. 1. Elliptical shapes or cornered shapes, in particular shapes with rounded edges, are also conceivable. The handle 10 could be provided at the basic lid body 2 as well as at the border 3, which is also true for other (non-depicted) well-known attachments, such as e.g. magnets, diaphragms and valves.

The basic lid body 2 preferably consists of heat resisting glass. Heat resisting plastics, ceramic materials, metal alloys or any combinations of the mentioned materials are also conceivable. For the use as cookware, transparent, that means clear or translucent materials, are advantageous to permit cooking under visual control. However, this property is not absolutely necessary.

The border 3 consists of a material harmless for food, such as a silicone material or a silicone containing material. However, other plastics from the group of thermosetting plastics, thermoplastics and elastomers can also be used. Ceramic materials or metal alloys or combinations of the mentioned materials would also be conceivable. The profile of the border 3 shown in FIG. 2 as a cross-section is only an example of the design of a cross-section. The sealing edge 5 and the rest surface 9 can also have ratios of dimensions and shapes deviating from these. Equally, the profile of the border 3 along the lid circumference can vary, integrated handles 10 or fixing points for attachments.

The sealing edge 5 is not absolutely required. If the sealing compound 4 is exactly proportioned, one can do without it. The vent gap 8 is neither absolutely required. A bead possibly forming when the sealing compound 4 is being introduced can be removed or smoothed. However, the sealing edge 5 is advantageous as it can help to increase the surface pressure between the border 3 and the basic lid body 2, so that any leaking of the sealing compound 4 is reliably prevented.

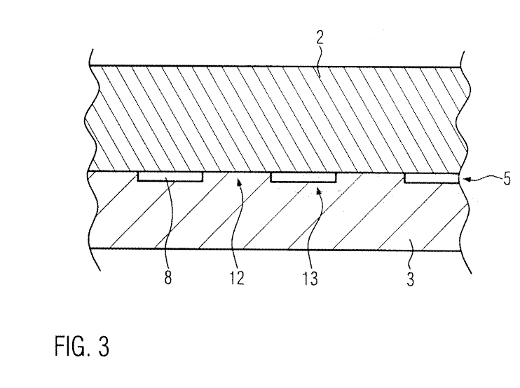

As one can see in FIG. 3, the sealing edge 5 can have a serrated design, so that along the sealing edge 5 regions 12 where the basic lid body 2 is resting on the sealing edge 5 alternate with regions 13 where the vent gap 8 is provided between the sealing edge 5 and the basic lid body 2. Thereby, a simple positioning of the basic lid body 2 onto the border 3 can be realized during the introduction of the sealing compound 4 without hindering the venting of the space 6. The number and shape of the vent gaps 8 can be arbitrarily selected. It is also possible not to provide any vent gap 8 in the border 3 or to replace the same by suited vent channels (not represented) in the border 3, so that the lid 2 is resting on the border 3 along the complete circumference. The proportion of sections 13 or vent gaps 8 in the length or the circumference of the sealing edge 5 can thus vary between 0% (no regions 13 provided) and 100% (one vent gap 8, no regions 12 provided). It is preferably between 1% and 99%, or possibly between 10% and 90%.

The sealing compound 4 preferably consists of a material harmless for food. However, this property is only compulsory if a part of the sealing compound 4 is exposed on the inner surface of the lid 1, e.g. if the sealing edge 5 does not exist, or if an excessive amount of sealing compound 4 has been introduced. Suited materials are e.g. plastics, silicone and resin, but other curing substances as well as mixtures of these substances are also possible.

During the introduction of the sealing compound 4, the same is capable of flow and/or creep. This permits to fill the space 6 with the sealing compound 4 up to the sealing edge 5. The adjustment of the sealing compound 4 to the contours of the basic lid body 2 and the border 3 permits a mechanically stable and permanently tight connection. If the sealing compound 4 is suitably selected and processed, the connection is not only watertight, but also airtight. Thereby, the escape of water vapor and the penetration of dirt between the border 3 and the basic lid body 2 are reliably prevented.

The sealing compound 4 preferably has the shape of a concave meniscus at its surface 4a visible from outside. For this, the adhesive forces between the sealing compound 4 that is capable of flow and the edge region 2a as well as the border 3 must be greater than the cohesive forces of the sealing compound 4. This can on the one hand be achieved by using materials having a suited surface or interfacial tension, on the other hand by a design of the basic lid body 2 and the border 3 that is correspondingly adapted to the materials, in particular by adjusting the inclinations of the surfaces 2b and 3a adjoining the sealing compound 4 in the region of the surface 4a. For forming a concave meniscus, the surfaces 2b and 3a must not fall below a minimum inclination with respect to the horizontal at the transition to the sealing compound 4, depending on the surface or interfacial tensions or the contact angle of the sealing compound 4, respectively.

The concave meniscus shape results in an optically particularly attractive transition between the basic lid body 2 and the border 3 and is advantageous in view of hygiene. The surface 4a of the sealing compound 4 can, however, be also essentially flat or have a convex meniscus shape, if required.

As can be taken from FIG. 2, the sealing compound 4 or the accommodation region 7, respectively, is arranged within the rest surface 9. The cured sealing compound 4 must therefore be at least hard enough not to be deformed considerably neither when the lid 1 is placed onto a base, nor by the weight of the lid 1, and to resist the shearing forces forming in the process.

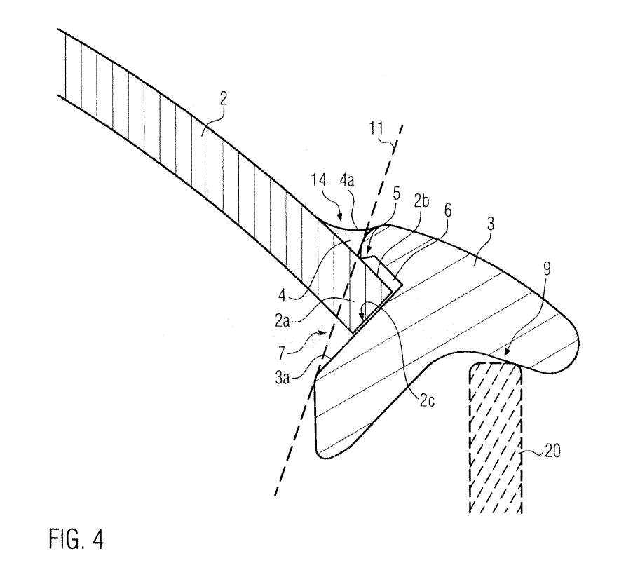

The second embodiment shown in FIG. 4 differs from the first embodiment with respect to the border profile and the connection region 14 between the basic lid body 2 and the border 3. According to this, an accommodation region 7 for the edge region 2a of the basic lid body 2 as well as a sealing edge 5 are also provided at the border 3, the sealing edge acting as flow limit for the sealing compound 4 towards the accommodation region 7. A space 6 is provided in the accommodation region 7 between the edge region 2a and the border 3.

The sealing compound 4 is introduced into the connection region 14 between the basic lid body 2 and the border 3 essentially outside the accommodation region 7, where the surface 4a of the sealing compound 4 located therebetween preferably takes the shape of a concave meniscus. The sealing edge 5 prevents the sealing compound 4 that is still capable of flow or creep from entering the accommodation region 7 or the space 6, respectively, during manufacture. Thus, the sealing edge 5 in this respect forms a limit between the accommodation region 7 and the connection region 14.

The second embodiment would be alternatively also possible without the sealing edge 5 and/or the space 6. However, the sealing edge 5 is advantageous as it can help to increase the surface pressure between the border 3 and the basic lid body 2, so that the penetration of the sealing compound 4 into the accommodation region 7 can be reliably prevented. In the second embodiment, preferably no vent gaps 8 or sections 13 are provided at the sealing edge 5.

According to FIG. 4, the space 6 is only embodied at one surface of the edge region 2a, that is at the surface 2b, while the circumferential side face 2c and the face 3a of the border 3 are connected in a form fit. A form fit between the edge region 2a and the border 3, however, is not absolutely necessary. The shape and position of the space 6 or the position and number of the contact surfaces between the edge region 2a and the border 3 can also vary. In the first and second embodiments, the basic lid body 2 and the border 3 can be connected to each other only by a material connection or in combination with a form fit.

The sealing compound 4 or the sealing edge 5, respectively, could be, either additionally, or alternatively, correspondingly also arranged at the bottom side of the basic lid body 2. For doing so, the basic lid body 2 and the border 3 only would have to be tilted by 180° during manufacture.

The border 3 preferably consists of a flexible material, such as a silicone material. This favors the sealing effect of the sealing edge 5 and permits the assembly of border profiles 3 which partially enclose the edge region 2a.

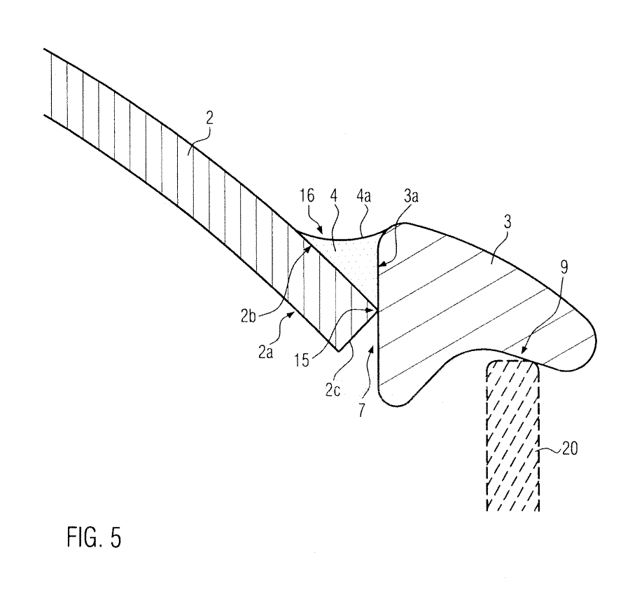

The third embodiment represented in FIG. 5 differs from the previous embodiments in that a circumferential sealing edge 15 is provided at the edge region 2a, which, in cooperation with the accommodation region 7 for the edge region 2a, in this example formed by the border surface 3a facing inwards, seals the connection region 16 for the sealing compound 4 to the bottom towards the face 2c. In the example, the connection region 16 is included by the surface 2b of the edge region 2a and the surface 3a above the sealing edge 15.

The faces 2b and 3a are inclined with respect to the horizontal such that the surface 4a of the sealing compound 4 essentially takes the shape of a concave meniscus. This permits a stable and impermeable as well as optically attractive connection.

The sealing compound 4 can possibly also connect several faces of the edge region 2a and/or the border 3, e.g. the faces 2c and 3a.

To ensure a particularly good sealing effect of the sealing edge 15 by increasing the surface pressure onto the accommodation region 7, the basic lid body 2 and the border 3 are fabricated with a low tolerance, if possible, e.g. by grinding the edge region 2a in the region of the sealing edge 15 or by injection-molding the border 3, the latter being preferably made of a rigid or only slightly flexible material.

The accommodation region 7 is embodied as flat surface 3a in the figure. In this case, the sealing compound 4 essentially forms a mere material connection. However, other shapes for the accommodation region 7 are also conceivable which result in a good sealing effect in combination with the sealing edge 15, such as steps or channels extending in the border 3 along the sealing edge 15. In this case, the connection could partially have a form fit.

In favor of a mechanically stable material-locking connection of the basic lid body 2 and the border 3, the sealing compound 4 preferably consists, in particular in the third embodiment, of a rigidly curing material, so that the position of the basic lid body 2 and the border 3 with respect to each other does not essentially change when the lid 2 is normally loaded, such as when the lid 1 is being placed onto a pot 20.

The features of the described embodiments can be arbitrarily combined. For example, different embodiments could be realized on the top or bottom side of the lid 1.

A disclosed cookware lid according to the first embodiment can be manufactured as follows:

A basic lid body 2 and a surrounding border 3 are held in an assembly position by means of a device not described more in detail. At the beginning, e.g. after the sealing compound 4 has been mixed, sealing compound 4 capable of flow or creep is introduced into the accommodation region 7 and into the space 6 between the basic lid body 2 and the border 3. In the process, air escapes through the vent gap 8 from the space 6, so that the sealing compound 4 advances to the sealing edge 5. As the sealing edge 5 is embodied as a flow barrier, the sealing compound 4 can essentially not pass the sealing edge 5. The sealing compound 4 capable of flow or creep adjusts to the contours of the basic lid body 2 and the border 3 and forms, after curing, a coherent bond and thus a watertight connection, e.g. as a result of chemical reaction, which permanently and mechanically stably connects the basic lid body 2 and the border 3 after the sealing compound 4 has solidified.

The sealing compound 4 is preferably proportioned such that its surface 4a adjoins suitably inclined sections of the basic lid body 2 and the border 3, so that its surface 4a is embodied in the shape of a concave meniscus.

Depending on the shape of the accommodation region 7, it can be advantageous to partially or completely introduce the sealing compound 4 into the accommodation region 7 before the basic lid body 2 and the border 3 are brought into their final assembly positions. Thereby, the vent gap 8 or the venting of the space 6 can be possibly omitted and/or assembly facilitated.

During the manufacture of the second and third embodiments, the basic lid body 2 and the border 3 are preferably positioned with respect to each other such that during the introduction of the sealing compound 4 a sufficient sealing effect of the sealing edge 5 or 15, respectively, is already ensured.

In the cookware lid 1 according to the disclosure, the basic lid body 2 and the border 3 are mechanically stably and watertightly connected not by clipping on or placing on in a form fit, but with the sealing compound 4, where the use of the sealing compound 4 permits to adapt the material and shape of the border 3 to different aesthetic and technical requirements while an impermeable, stable and hygienically impeccable connection is created.

1. Cookware lid, comprising a basic lid body a surrounding border, and the basic lid body being connected to the border by means of a sealing compound having a surface, and the surface having the shape of a concave meniscus.

2. Cookware lid according to claim 1, wherein the contour of the sealing compound is adapted to the contours of the basic lid body and the border.

3. Cookware lid according to claim 1, wherein the basic lid body and the border are connected with a watertight sealing compound.

4. Cookware lid according to claim 1, wherein the border comprises a rest surface arranged to surround the sealing compound to rest on a piece of cookware, and the cured sealing compound is hard enough not to be deformed when the lid is placed onto the piece of cookware.

5. Cookware lid according to claim 1, wherein the basic lid body is transparent.

6. Cookware lid according to claim 1, wherein the sealing compound consists of a material harmless for food.

7. (canceled)

8. Cookware lid according to claim 1, wherein the border consists of a material harmless for food.

9. Cookware lid according to claim 1, wherein the border comprises silicone material.

10. Cookware lid according to claim 1, wherein a sealing edge is embodied one of in the border or at the basic lid body which acts as a flow barrier for the sealing compound during the introduction of the sealing compound between the border and the basic lid body.

11. Cookware lid according to claim 1, wherein an accommodation region for a circumferential edge section of the basic lid body is embodied in the border, where the volume of the accommodation region is larger than the volume of the edge section, and that a space between the basic lid body and the border provided in the accommodation region is filled with the sealing compound.

12. Cookware lid according to claim 11, and wherein a vent gap is provided between the sealing edge and the basic lid body.

13. Method for the manufacture of a cookware lid with a basic lid body and a surrounding border, comprising:
providing a basic lid body and a border and;
connecting the basic lid body and the border by means of a sealing compound having a surface, wherein the surface has the shape of a concave meniscus.

14. Method according to claim 13, and introducing the sealing compound between the basic lid body and the border, where a sealing edge one of embodied at the border in combination with the basic lid body, or a sealing edge embodied at the basic lid body in combination with the border, acts as a flow barrier for the sealing compound.

15. Method according to claim 13, and introducing the sealing compound between the basic lid body and the border in a state where it is capable of flow and/or creep, and in the process adjusts to the contours of the basic lid body and the border.

16. Cookware lid according to claim 5, wherein the basic body lid is made of glass.

17. Cookware lid according to claim 8, wherein the material harmless for food comprises one of plastics, resin, or a curing material.
